(19) United States
(12) Patent Application Publication
(10) Pub. No.: US 2025/0392593 A1
(43) Pub. Date: Dec. 25, 2025

(54) INFORMATION PROCESSING APPARATUS, SYSTEM, DISPLAY METHOD, PROGRAM, AND RECORDING MEDIUM

(71) Applicant: SHARP KABUSHIKI KAISHA, Sakai City (JP)

(72) Inventor: YOSUKE OSAKI, Sakai City (JP)

(21) Appl. No.: 19/202,156

(22) Filed: May 8, 2025

(30) Foreign Application Priority Data
Jun. 21, 2024 (JP) 2024-100411

(51) Int. Cl. H04L 9/40; G06F 9/451

(52) U.S. Cl. CPC H04L 63/0876; G06F 9/451

(57) ABSTRACT

Included are a storage and a controller. The controller displays a first screen in a case that a user logs into a service using a first attribute account, displays a second screen in a case that the user logs into the service using a second attribute account, and displays information requesting input of the second attribute account when specific information is stored in the storage at a time of logging into the service using the first attribute account.

### TECHNICAL FIELD

The disclosure relates to an information processing apparatus and the like.

### BACKGROUND ART

It has been known that access is permitted when a user identifier and an application identifier in pairs are matched.

### SUMMARY

### Technical Problem

An object of the disclosure is to provide, for example, an information processing apparatus and the like capable of displaying an appropriate screen in accordance with an attribute of a login account.

### Solution to Problem

An information processing apparatus according to the disclosure includes a storage and a controller, wherein the controller displays a first screen in a case that a user logs into a service using a first attribute account, displays a second screen in a case that the user logs into the service using a second attribute account, and displays information requesting input of the second attribute account in a case that specific information is stored in the storage at a time of logging into the service using the first attribute account.

A system according to the disclosure includes a server apparatus that provides a service, and a display apparatus that executes a first application communicating with the service, wherein the display apparatus executes the first application in such a manner as to display with a first user interface in a case that a user logs into the service using a first attribute account, executes the first application in such a manner as to display with a second user interface in a case that the user logs into the service using a second attribute account, and displays information requesting the user to log into the service using the second attribute account in a case that the second application is installed in the display apparatus and that the user logging into the service using the first attribute account.

A display method according to the disclosure is a display method of an information processing apparatus including a storage, the method including: displaying any of a first screen in a case that a user logs into a service using a first attribute account and a second screen in a case that the user logs into the service using a second attribute account; and displaying information requesting input of the second attribute account in a case that specific information is stored in the storage at a time of logging into the service using the first attribute account.

A program of the disclosure causes a computer including a storage to enable a function to display a first screen in a case that a user logs into a service using a first attribute account, a function to display a second screen in a case that the user logs into the service using a second attribute account, and a function to display information requesting input of the second attribute account in a case that specific information is stored in the storage at a time of logging into the service using the first attribute account.

### Advantageous Effects of Disclosure

According to the disclosure, an appropriate screen can be displayed in accordance with an attribute of a login account.

### BRIEF DESCRIPTION OF THE DRAWINGS

FIG. 1 is a diagram illustrating an example of a system according to an embodiment of the disclosure.

FIG. 2 is a diagram illustrating a configuration of the system according to the embodiment of the disclosure.

FIG. 3A is a diagram illustrating a table stored in a storage of a server according to the embodiment of the disclosure.

FIG. 3B is a diagram illustrating a table stored in the storage of the server according to the embodiment of the disclosure.

FIG. 4 is a diagram illustrating an example of a display screen as an operation example according to the embodiment of the disclosure.

FIG. 5 is a diagram illustrating an example of a display screen as an operation example according to the embodiment of the disclosure.

FIG. 6 is a diagram illustrating an example of a display screen as an operation example according to the embodiment of the disclosure.

FIG. 7 is a diagram illustrating an example of a display screen as an operation example according to the embodiment of the disclosure.

FIG. 8 is a flowchart explaining an example of a process according to the embodiment of the disclosure.

FIG. 9 is a diagram illustrating an example of a display screen as an operation example according to the embodiment of the disclosure.

FIG. 10 is a flowchart explaining an example of a process according to the embodiment of the disclosure.

FIG. 11 is a diagram illustrating an example of a display screen as an operation example according to the embodiment of the disclosure.

FIG. 12 is a flowchart explaining an example of a process according to the embodiment of the disclosure.

FIG. 13 is a flowchart explaining an example of a process according to the embodiment of the disclosure.

FIG. 14 is a diagram illustrating an example of a display screen as an operation example according to the embodiment of the disclosure.

### DETAILED DESCRIPTION OF THE DISCLOSURE

In a general information processing apparatus, when different operation modes of an application are executed based on attributes of accounts, in a case where access to the application is permitted only by an application identifier, there is a possibility that an appropriate user interface cannot be displayed, or the application cannot be executed in an appropriate operation mode unless logging into the application is performed using an appropriate account. For example, there is a case in which accounts have attributes such as a shared account for login from a shared information processing apparatus shared by a plurality of users and a personal account used by an individual user. In such a case, in the shared information processing apparatus, when a user logs into a service to execute an application, there is a case where although the user wants to operate the application in a shared operation mode to make the shared information processing apparatus display a screen, the application is caused to operate in a personal operation mode due to the login using a personal account.

In order to solve the problems described above, an embodiment of the disclosure will be described below with reference to the drawings. In the drawings, the same or equivalent components are denoted by the same reference numerals and signs, and description thereof will not be repeated.

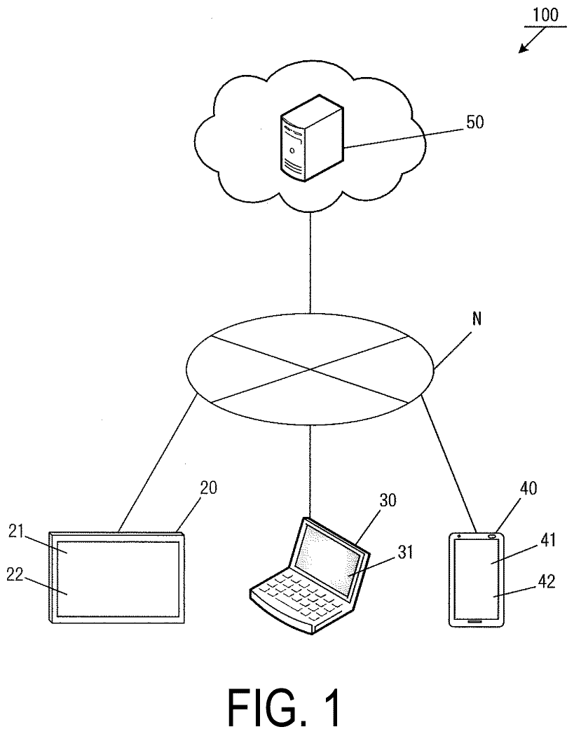

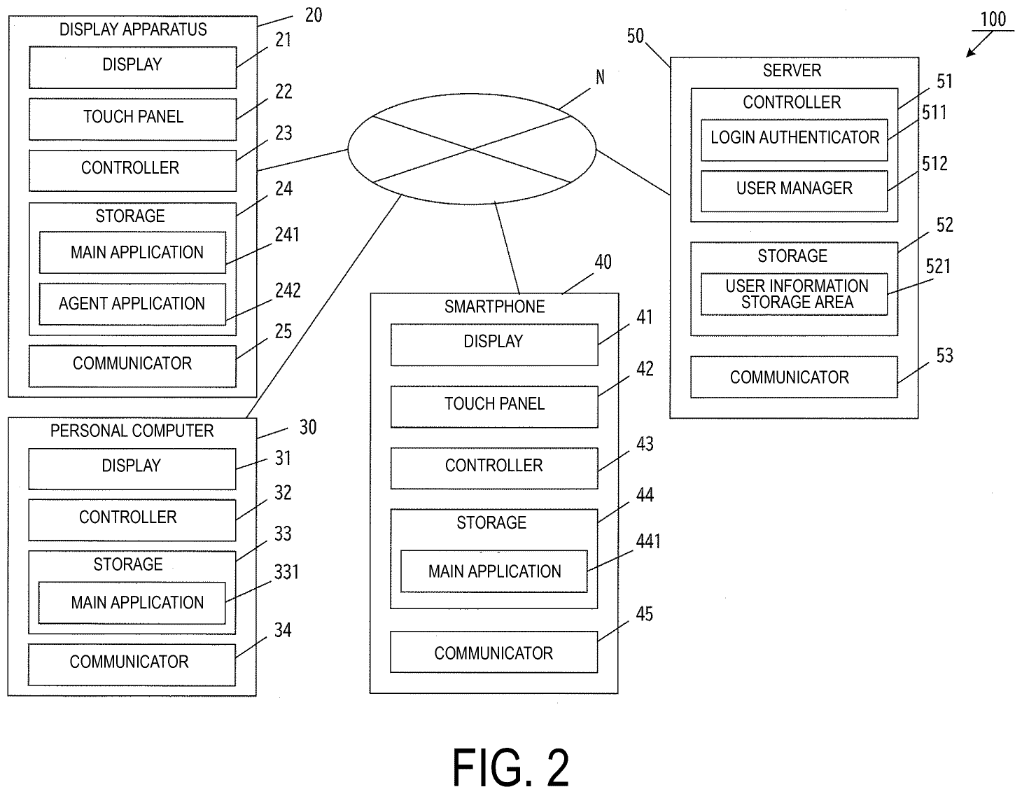

As illustrated in FIGS. 1 and 2, a system 100 includes a display apparatus (interactive whiteboard (IWB)) 20, a personal computer 30, a smartphone 40, and a server 50. The display apparatus 20, the personal computer 30, and the smartphone 40 each correspond to an example of an “information processing apparatus” of the disclosure. The personal computer 30 and the smartphone 40 may each be an external terminal and may each be an example of a “terminal apparatus” of the disclosure. The apparatuses such as the personal computer and the smartphone include other forms. Examples of the information processing apparatus and the terminal apparatus may include a tablet, a wearable terminal apparatus, and the like.

The system 100 can execute, in any apparatus, an application suitable for use in, for example, a communication service, a cooperation service, or a conference service (hereinafter referred to as a “conference service”). In the disclosure, an application suitable for use in a conference service is referred to as a main application (a first application).

The main application has two user interfaces. A first user interface (a first screen) is a user interface suitable for use in an information processing apparatus individually used by an individual. A second user interface (a second screen) is a user interface suitable for use in an information processing apparatus, such as a large display apparatus, that is shared by participants in a conference or the like.

Through the second user interface, a user may present conference materials and execute a conference application (e.g., a chat tool, a whiteboard tool, or a file sharing tool). Through the first user interface, a user may instruct to display the conference materials, select a display apparatus executing the main application, and operate the display apparatus.

The main application operates in a first operation mode for providing the first user interface, and operates in a second operation mode for providing the second user interface. The main application provides, for example, a function of executing remote control in the second operation mode. When the main application is operating in the first operation mode, the main application can remotely control an apparatus executing in the second operation mode.

For example, the main application executing in the first operation mode can communicate with the main application executing in the second operation mode via the server 50. One or more applications executing in the first operation mode communicate with the main application executing in the second operation mode, thereby establishing a conference service. To start this conference service, the user logs into the service via the main application (the server 50 or any authentication server) by an account.

In the following embodiment, the information processing apparatus (display apparatus) in which the main application is operating in the second operation mode and the information processing apparatuses (personal computer 30, smartphone 40) in which the main application is operating in the first operation mode communicate with each other via the server 50, but each information processing apparatus may directly communicate with each other.

The main application can display connection information at the second user interface. For example, when the connection information is acquired by the smartphone 40 as a terminal apparatus, the user can operate the main application of the smartphone 40 in the first operation mode.

Further, in the system, an agent application is executed as a second application in an apparatus to be operated (the display apparatus 20 in the present embodiment). The agent application is an application that cooperates with an external terminal. For example, when the agent application is executed in the display apparatus 20, connection information for the external terminal to connect to the display apparatus 20 is generated. The connection information may be generated when the user properly logs into the service or may be generated when the main application is executing in the second operation mode.

The external terminal performs connection (pairing) with the display apparatus 20 by reading the connection information. When the external terminal transmits an operation signal to the display apparatus 20, the agent application acquires the operation signal and operates the display apparatus 20. That is, the external terminal can remotely operate the display apparatus 20 via the agent application.

The display apparatus 20 includes a display 21 and a touch panel 22, which are integrated with each other, a controller 23, a storage 24, and a communicator 25. In a case where the display apparatus 20 is a large apparatus, it can be used as an electronic blackboard, for example.

The display 21 is a display device capable of displaying various types of information and execution screens. The display 21 may be, for example, a display device such as a liquid crystal display (LCD), an organic electro luminescence (EL) display, or an electrophoresis display. The display 21 includes an interface capable of connecting with a display device. For example, the display 21 may include an external display device connected via a High-Definition Multimedia Interface (HDMI) (trade name), a Digital Visual Interface (DVI), or a Display Port. In the present embodiment, the display 21 notifies the user of, for example, information related to login of a service. Further, the display 21 may correspond to an example of a “notifier” of the disclosure.

The touch panel 22 is provided as an example of an operation unit. The touch panel 22 is a device capable of receiving input operations from a user. Examples of a method by which the touch panel 22 receives input from the user include, but are not limited to, a capacitance method, a resistive film method, an infrared blocking method, and an ultrasonic surface acoustic wave method. The touch panel 22 can receive one or multiple inputs from the user. While not limited to the method of detecting a position directly touched by a fingertip, a touch pen, or the like, a non-contact input method (also referred to as “hover input” or “hover touch”) may be employed that is capable of detecting a position which a fingertip or the like approaches. An operation button other than the touch panel or an external input device such as a mouse or a keyboard may be used as an operation unit to enable the function of the operation unit.

The controller 23 controls the overall display apparatus 20. The controller 23 enables various functions by loading and executing various programs stored in the storage 24 (e.g., a storage component or ROM). The controller 23 may be implemented by, for example, one or multiple control devices/arithmetic devices (central processing unit (CPU), system on a chip (SoC)). The controller 23 may include a control circuit such as an electronic circuit. The programs may be programs for causing a plurality of processors to function as the processing unit.

The controller 23 executes a main application 241 and an agent application 242 stored in the storage 24. In the present embodiment, the main application 241 has a function for supporting a conference via the server 50 as an example of a function. In the present embodiment, the agent application 242 executes intermediate processing for indication information of operation from an external terminal. The personal computer 30 and the smartphone 40 are external terminals with respect to the display apparatus 20. The agent application 242 is an application suitably used for the display apparatus 20. For example, the agent application 242 executes intermediate processing for indication information of operation from the external terminals (the personal computer 30 and smartphone 40). The main application 241 corresponds to an example of a “first application” of the disclosure. The agent application 242 corresponds to an example of a “second application” of the disclosure.

The storage 24 stores programs, data, and the like. The storage 24 may include, for example, a storage component, a ROM, or a RAM. The storage 24 may be configured to include, for example, a cache memory included in another functional unit (e.g., the controller 23 or the communicator 25).

The storage component is a non-volatile storage device capable of storing programs and data. For example, the storage component may include a storage device such as a semiconductor memory or a solid state drive (SSD). The storage component may be configured as a storage card that can be connected to the exterior. The storage component may be, for example, a storage area on a cloud.

The ROM is a non-volatile memory capable of holding programs and data even when the power is turned off.

The RAM is a main memory mainly used by the controller 23 when executing processing. The RAM is a rewritable memory that temporarily holds a program read out from the storage component or the ROM, data including an execution result, and the like.

In the present embodiment, the storage 24 stores the main application 241 and the agent application 242. The main application 241 and the agent application 242 are preferably configured by using separate programs. The main application 241 and the agent application 242 may be configured by using a single program. The storage 24 may further store a login control program.

The communicator 25 performs bidirectional communication with the server 50 via a network N, for example. The communicator 25 performs bidirectional communication with the personal computer 30 and the smartphone 40 via the server 50, for example. The communicator 25 is a communication interface configured to communicate with other apparatuses. The communicator may be, for example, a network interface capable of providing wired connection such as Ethernet (trade name) or wireless connection such as IEEE 802.11a/b/g/n. One or multiple communicators 25 may be provided. For example, the communicator 25 may include a LAN interface such as a wired LAN and an interface for short-range wireless communication such as Bluetooth (trade name).

The personal computer 30 includes a display 31, a controller 32, a storage 33, and a communicator 34.

The display 31 is a display device capable of displaying various types of information, an execution screen, and the like. The display 31 may be, for example, a display device such as a liquid crystal display (LCD), an organic electro luminescence (EL) display, or an electrophoresis display. The display 31 includes an interface capable of connecting with a display device. For example, the display 31 may include an external display device connected via a High-Definition Multimedia Interface (HDMI) (trade name), a Digital Visual Interface (DVI), or a Display Port.

The controller 32 controls the overall personal computer 30. The controller 32 enables various functions by loading and executing various programs stored in the storage 33 (e.g., a storage component or ROM). The controller 32 may be implemented by, for example, one or multiple control devices/arithmetic devices (central processing unit (CPU), system on a chip (SoC)). The controller 32 may include a control circuit such as an electronic circuit. The programs may be programs for causing a plurality of processors to function as the processing unit. The controller 32 executes a main application 331 stored in the storage 33.

The storage 33 stores programs, data, and the like. The storage 33 may include, for example, a storage component, a ROM, or a RAM. The storage 33 may be configured to include, for example, a cache memory included in another functional unit (e.g., the controller 32 or the communicator 34). The storage 33 stores the main application 331.

The communicator 34 performs bidirectional communication with the server 50 via the network N, for example. The communicator 34 performs bidirectional communication with the display apparatus 20 via the server 50, for example. The communicator 34 is a communication interface configured to communicate with other apparatuses. The communicator may be, for example, a network interface capable of providing wired connection such as Ethernet (trade name) or wireless connection such as IEEE802.11a/b/g/n. One or multiple communicators 34 may be provided. For example, the communicator 34 may include a LAN interface such as a wired LAN and an interface for short-range wireless communication such as Bluetooth (trade name).

The smartphone 40 includes a display 41, a touch panel 42, a controller 43, a storage 44, and a communicator 45.

The display 41 is a display device capable of displaying various types of information and execution screens. The display 41 may be, for example, a display device such as a liquid crystal display (LCD), an organic electro luminescence (EL) display, or an electrophoresis display. The display 41 includes an interface capable of connecting with a display device. For example, the display 41 may include an external display device connected via a High-Definition Multimedia Interface (HDMI) (trade name), a Digital Visual Interface (DVI), or a Display Port.

The touch panel 42 is provided as an example of an operation unit. The touch panel 42 is a device that allows a user to input operations. Examples of a method by which the touch panel 42 receives input from the user include, but are not limited to, a capacitance method, a resistive film method, an infrared blocking method, and an ultrasonic surface acoustic wave method. The touch panel 42 can receive one or multiple inputs from the user. An operation button other than the touch panel or an external input device such as a mouse or a keyboard may be used as an operation unit to enable the function of the operation unit.

The controller 43 controls the overall smartphone 40. The controller 43 enables various functions by loading and executing various programs stored in the storage 44 (e.g., a storage component or ROM). The controller 43 may be implemented by, for example, one or multiple control devices/arithmetic devices (central processing unit (CPU), system on a chip (SoC)). The controller 43 may include a control circuit such as an electronic circuit. The programs may be programs for causing a plurality of processors to function as the processing unit. The controller 43 executes a main application 441 stored in the storage 44.

The storage 44 stores programs, data, and the like. The storage 44 may include, for example, a storage component, a ROM, or a RAM. The storage 44 may be configured to include, for example, a cache memory included in another functional unit (e.g., the controller 43 or the communicator 45). The storage 44 stores the main application 441.

The communicator 45 performs bidirectional communication with the server 50 via the network N, for example. The communicator 45 performs bidirectional communication with the display apparatus 20 via the server 50, for example. The communicator 45 is a communication interface configured to communicate with other apparatuses. The communicator is preferably, for example, a network interface capable of providing wireless connection such as IEEE 802.11a/b/g/n, but is allowed to be a wired connection interface. One or multiple communicators 45 may be provided. For example, the communicator 45 may include a LAN interface such as a wireless LAN and an interface for short-range wireless communication such as Bluetooth (trade name). The communicator 45 may be a communication interface that can be connected to mobile communication networks such as 4G/5G/6G.

The server 50 includes a controller 51, a storage 52, and a communicator 53. The server 50 provides a service for supporting a conference and a conference service by communicating with the main applications. For example, the server 50 can implement authentication of users, management of licenses, pairing between the display apparatus 20 and external terminals (e.g., the personal computer 30 and/or the smartphone 40), file transfer between apparatuses, remote operation from the external terminals with respect to the display apparatus 20 (remote operation of the operation unit of the display apparatus 20), and the like.

The controller 51 controls the overall server 50. The controller 51 enables various functions by loading and executing various programs stored in the storage 52 (e.g., a storage component or ROM). The controller 51 may be implemented by one or multiple control devices/arithmetic devices (central processing unit (CPU), system on a chip (SoC)). The controller 51 may include a control circuit such as an electronic circuit. The programs may be programs for causing a plurality of processors to function as the processing unit.

The controller 51 enables functions of a login authenticator 511 and a user manager 512 by executing the programs stored in the storage 52.

The login authenticator 511 performs login authentication based on account information in response to a request from a user. For example, the main application 241, the main application 331, and the main application 441 each transmit a login request including account information (ID, password, and the like) to the server 50. When the server 50 receives the login request via the communicator 53, the login authenticator 511 performs login authentication based on user information stored in a user information storage area 521. Then, the login authenticator 511 transmits a result of the login authentication as a login response to the main application 241, the main application 331, or the main application 441, which is a request source.

The login authenticator 511 transmits the login response including information indicating whether the login is correctly performed. In addition, the login authenticator 511 transmits the login response including the attribute of the account having made the login request. The attribute of the account may include “personal account” as a first attribute and “shared account” as a second attribute.

The main application 241, the main application 331, or the main application 441 having received the login response switches a screen to be displayed by the application between the first screen (first user interface) and the second screen (second user interface) in accordance with the attribute of the account, and then displays the screen. That is, the main application can switch the operation mode in accordance with the attribute of the application.

The user manager 512 manages information of a user. For example, the user manager 512 can create, delete, or change an account of the user. The user manager 512 can assign a license to the account of the user or cancel the license.

The storage 52 stores data and computer programs. For example, the storage 52 temporarily stores data necessary for each process of the controller 51. The storage 52 includes storage devices (a main storage device and an auxiliary storage device) such as a memory and a hard disk drive. The storage 52 may include a removable medium.

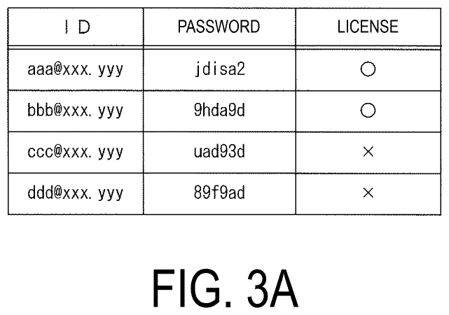

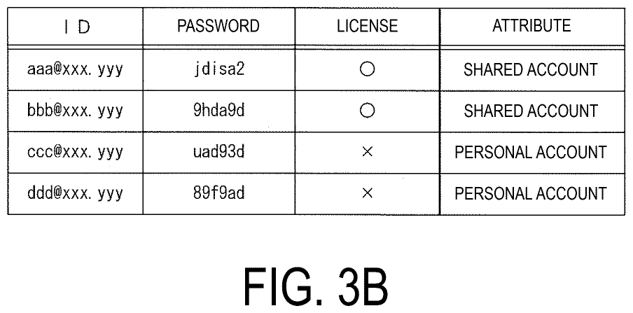

An example of user information stored in the user information storage area 521 is illustrated in FIG. 3A. As the user information, for example, account information (ID, password) of the account and whether a license is assigned to the account are stored. As an ID for identifying the account, for example, a unique identification ID used in the service or an email address can be used. In the present embodiment, an email address (for example, “aaa@ xxx.yyy”) is used. The ID may be a character string or a number, or a combination of a character string, a number, and a symbol. As a method of identifying the account, for example, authentication of another service (e.g., OAuth authentication) may be used without directly storing the account information.

In the present embodiment, the account has an attribute. The attribute of the account includes a first attribute and a second attribute. The first attribute is an attribute of the account used for logging into the service from a personal apparatus (the personal computer 30, the smartphone 40) mainly used by an individual. The second attribute is an attribute of the account mainly used for logging into the service from a shared apparatus (the display apparatus 20) shared and used by a plurality of persons. The first attribute account may be referred to as “personal account”, and the second attribute account may be referred to as “shared account”.

Here, the attribute of an account may be distinguished depending on whether a license (for example, “Meeting License” which is a license that allows using of the conference system) is given to the account. For example, referring to the user information storage area 521 in FIG. 3A, the attribute of an account given with a license indicates a shared account. An account to which no license is given indicates a personal account.

The user information storage area 521 may store the attribute of an account as account information, as illustrated in FIG. 3B. For example, when the account is a personal account, the controller 51 stores information including “personal account” as an attribute of the account information. When the account is a shared account, the controller 51 stores information including “shared account” as an attribute of the account information.

The communicator 53 performs bidirectional communication with the display apparatus 20, the personal computer 30, and the smartphone 40 via the network N, for example. The communicator 53 may include, for example, a network interface controller (NIC) configured to perform communication in accordance with a predetermined communication protocol. The communicator 53 may include, for example, a wireless communication module.

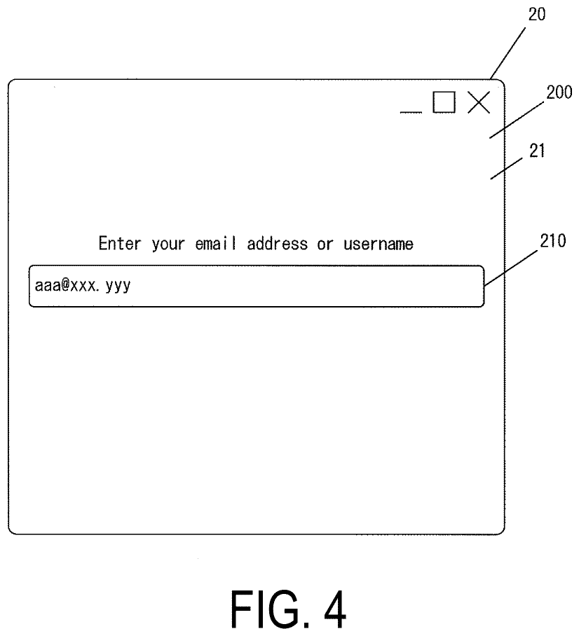

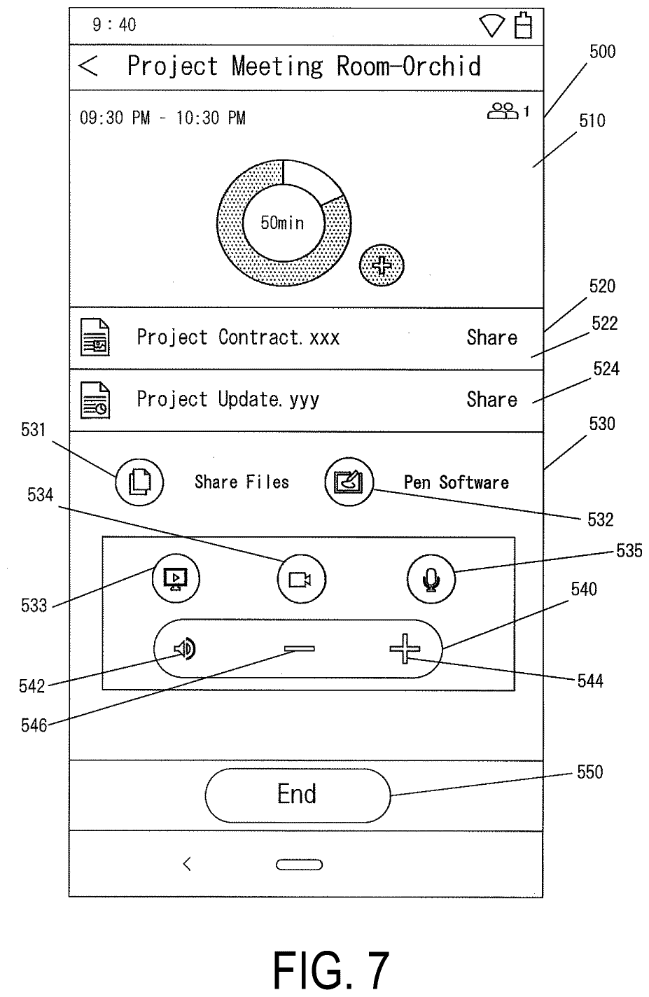

Operations of the display apparatus 20 will be described below with reference to FIG. 1 to FIG. 7. FIG. 4 to FIG. 6 are diagrams each illustrating an example of a display screen displayed on the display 21 of the display apparatus 20. FIG. 7 is a diagram illustrating an example of a display screen displayed on the display 41 of the smartphone 40.

As illustrated in FIG. 4, when the main application 241 is activated in the display apparatus 20, the controller 23 displays a login screen 200 on the display 21. The login screen 200 includes an account information input section 210. An ID of an account is input to the account information input section 210 by the user. The login screen 200 is a third screen displayed prior to the operation by switching between the first operation mode and the second operation mode.

When the ID of the account is input by the user, the controller 23 of the display apparatus 20 causes a password input section (not illustrated) to be displayed on the display 21 of the display apparatus 20. When a password of the account is input by the user, the controller 23 performs login authentication.

Specifically, the controller 23 transmits to the server 50 the account information (ID and password) input to the server 50. Then, the login authenticator 511 of the server 50 determines whether it is possible to log into the service using the account information. Then, in a case where the login has been correctly performed by the login authenticator 511, the controller 23 receives a login response indicating that the login has been correctly performed. In a case where the login has not been correctly performed by the login authenticator 511, the controller 23 receives a login response indicating that the login has not been correctly performed.

When the login has been correctly made, the controller 23 identifies the attribute of the account included in the login response. For example, when the ID of the account for which the login authentication is performed is “aaa@ xxx.yyy”, the controller 23 determines that the attribute of the account corresponding to the above ID is “shared account”. For example, when the account for which the login authentication is performed is “ccc@ xxx.yyy”, the controller 23 determines that the attribute is a personal account.

When the attribute of the account having logged into the service is “shared account”, the main application 241 operates in the second operation mode. Accordingly, the main application 241 displays the screen with the second user interface.

On the other hand, when the attribute of the account having logged into the service is “personal account”, the operation is performed in the first operation mode. Accordingly, the main application 241 displays the screen with the first user interface.

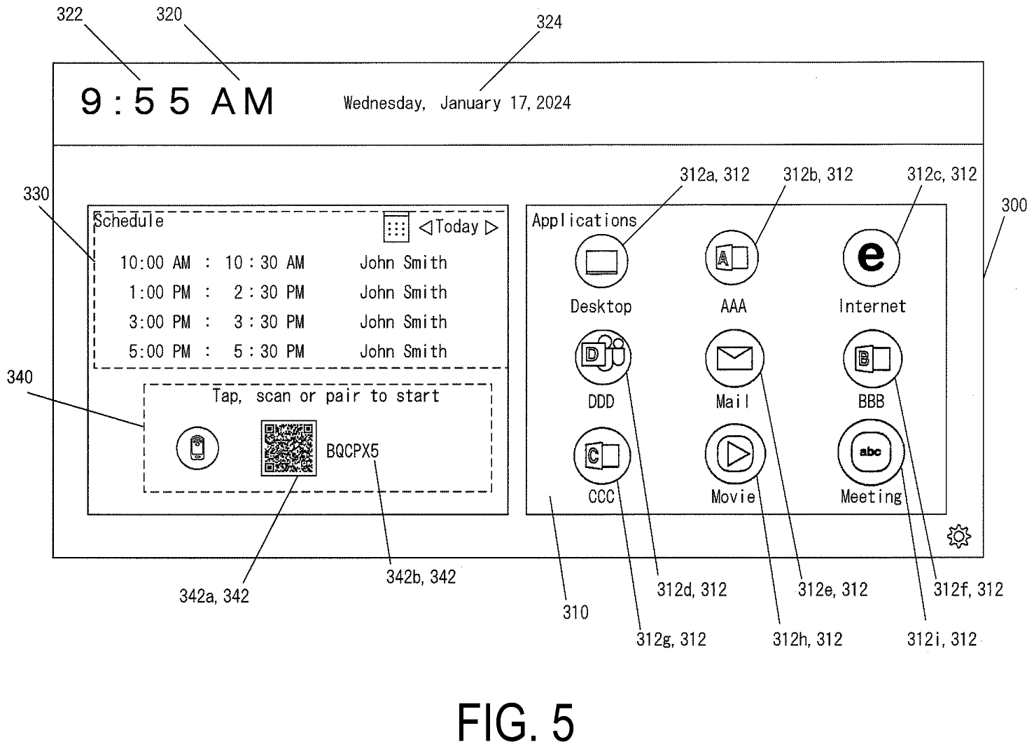

As described above, the controller 23 displays different user interfaces on the display 21 depending on the attributes of the accounts having logged in to the service. Specifically, when the attribute of the account that has logged into the service is “shared account”, the controller 23 executes the main application 241 in the second operation mode, and displays a home screen 300 as the second screen on the display 21 as illustrated in FIG. 5. The home screen 300 is, for example, a shared home screen.

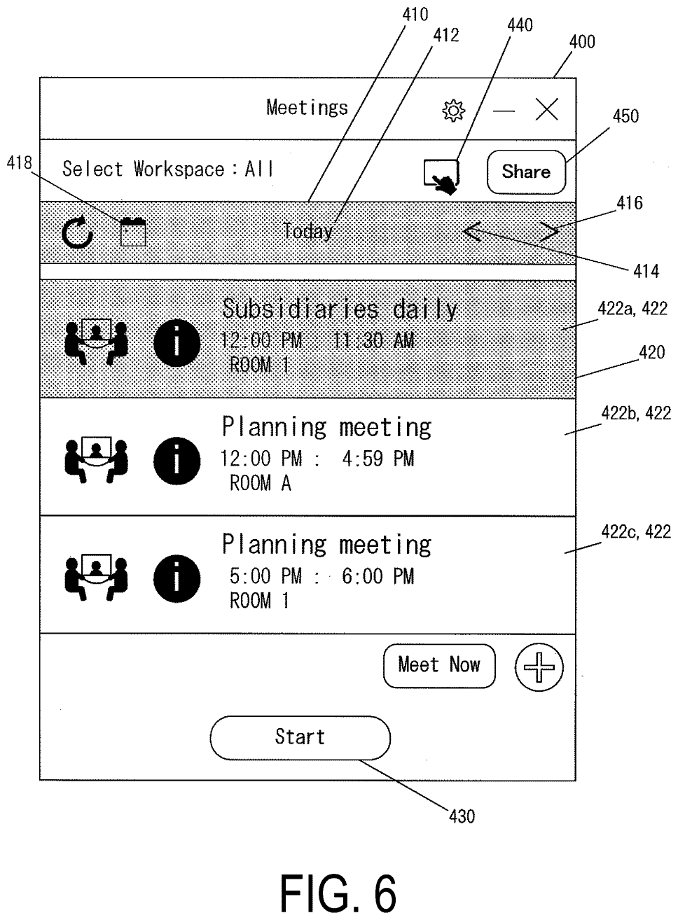

On the other hand, when the attribute of the account having logged into the service is “personal account”, the controller 23 executes the main application 241 in the first operation mode and displays a home screen for personal use. FIG. 6 is an example of a display screen when a home screen 400 as the first screen is displayed on the display apparatus 20. The home screen 400 is, for example, a personal home screen. The home screen 400 may be displayed, for example, in a partial area of the display 31 of the personal computer 30 while not limited to the display apparatus 20.

The home screen 300 will be described with reference to FIG. 5. As illustrated in FIG. 5, the home screen 300 includes an application display portion 310, a current time display portion 320, a conference schedule display portion 330, and a connection information display portion 340.

The application display portion 310 displays applications that can be used in the display apparatus 20. The application display portion 310 includes a plurality of icon images 312. The plurality of icon images 312 include an icon image 312b, an icon image 312c, an icon image 312d, an icon image 312e, an icon image 312f, an icon image 312g, an icon image 312h, and an icon image 312i. When an icon image 312 is touched by the user, the controller 23 activates an application corresponding to the touched icon image 312. For example, when the icon image 312c is touched by the user, the controller 23 activates an Internet browser application.

The current time display portion 320 displays the current time. The current time display portion 320 includes a time display portion 322 and a date display portion 324. The time display portion 322 displays the current time. The date display portion 324 may display the current date and day of the week.

The connection information display portion 340 displays an image indicating connection information 342. The connection information 342 indicates connection information regarding connection of remote operation from an external terminal. The connection information 342 includes at least one of a two-dimensional code 342a or a character string 342b. The two-dimensional code 342a is, for example, a QR code (trade name). The character string is, for example, a six-digit character string including at least one of an alphabet or a numeral. The user can connect (pair) an external terminal and the display apparatus 20 using the connection information 342 and remotely operate the display apparatus 20 from the external terminal.

For example, the user can connect the smartphone 40 to the display apparatus 20 by capturing the two-dimensional code 342a with a camera of the smartphone 40. Further, the user can connect the personal computer 30 to the display apparatus 20 by inputting the character string 342b to the personal computer 30.

The home screen 400 for personal use will be described with reference to FIG. 6. As illustrated in FIG. 6, the home screen 400 includes a schedule change portion 410, a conference schedule display portion 420, a start button 430, a remote operation portion 440, and a share setting button 450.

The schedule change portion 410 includes a date display portion 412, a previous schedule change button 414, a subsequent schedule change button 416, and a calendar display portion 418. The date display portion 412 displays a date. The previous schedule change button 414 is a button for changing the date displayed in the date display portion 412 to a previous schedule. Specifically, the user can change the date displayed in the date display portion 412 to a date one day earlier by touching the previous schedule change button 414. The subsequent schedule change button 416 is a button for changing the date displayed in the date display portion 412 to a subsequent schedule. Specifically, the user can change the date displayed in the date display portion 412 to a date one day later by touching the subsequent schedule change button 416.

The conference schedule display portion 420 acquires schedule information of a user who has logged into the service, and displays a schedule of a conference registered as a conference to be attended by the user having logged into the service, on the date displayed in the date display portion 412. The conference schedule display portion 420 includes a plurality of conference content display portions 422. The plurality of conference content display portions 422 include a conference content display portion 422a, a conference content display portion 422b, and a conference content display portion 422c. Each of the plurality of conference content display portions 422 includes, for example, a name of a conference, a conference time, and a conference room name.

The start button 430 is a button for starting a conference. When the start button 430 is touched by the user, the conference selected in the conference schedule display portion 420 is started, and a screen 500 illustrated in FIG. 7 is displayed. The conference refers to, for example, a Web conference, a TV conference, or a video conference.

The remote operation portion 440 is an icon image for remotely operating the display apparatus 20. When the user touches the remote operation portion 440, the screen 500 for remote operation illustrated in FIG. 7 is displayed on the display 31 of the personal computer 30 serving as an external terminal. When the remote operation portion 440 is touched, for example, a trackpad screen may be displayed on the personal computer 30 to provide an operation user interface. In the personal computer 30, when the trackpad is operated, an operation signal (information regarding the operation) of the displayed trackpad is transmitted to the display apparatus 20. An icon image for activating a remote trackpad function may be displayed in the screen of FIG. 7 in the same manner as the icon image of the remote operation portion 440, and the display apparatus 20 can be remotely operated by the remote trackpad function both in the case where the conference has not been started yet and in the case where the conference is being held.

The share setting button 450 is a button for sharing electronic data such as an image or a file. When the user touches the share setting button 450, a screen for sharing electronic data is displayed.

The remote operation screen 500 will be described with reference to FIG. 7. The remote operation screen 500 is a screen for remotely operating the display apparatus 20. As illustrated in FIG. 7, the remote operation screen 500 includes a conference information display portion 510, a shared file display portion 520, a function setting portion 530, a volume setting portion 540, and an end button 550.

The conference information display portion 510 displays information of the conference. The information of the conference includes, for example, a name of the conference, a conference time, an elapsed time of the conference, and the number of persons participating in the conference.

The shared file display portion 520 displays information of a file registered in the conference displayed in the conference information display portion 510. The file is, for example, electronic data attached at the time of conference guidance. The shared file display portion 520 includes a first shared file display portion 522 and a second shared file display portion 524. The user can easily share the file by touching the shared file display portion 520. For example, by touching the shared file display portion 520, the user can display the file, selected by the touch, on the display 21 of the display apparatus 20, the display 31 of the personal computer 30 of a conference attendee, and the display 41 of the smartphone 40 of a conference attendee.

The function setting portion 530 displays an icon image for setting a function regarding the remote operation of the display apparatus 20. The function setting portion 530 includes a file sharing button 531, a pen software button 532, a screen sharing button 533, a camera button 534, and a microphone mute button 535. The file sharing button 531 is a button for adding a file to be shared. When the user touches the file sharing button 531, a selection screen for adding a shared file is displayed. The file selected by the user to be added is displayed in the shared file display portion 520. The pen software button 532 is used to use pen software.

When the user touches the pen software button 532, it is possible to activate a whiteboard or change a pen input setting by remote operation with respect to the display apparatus 20.

The volume setting portion 540 displays an icon image for setting the volume of the display apparatus 20. The volume setting portion 540 includes a sound emission/mute switch button 542, a volume increase button 544, and a volume decrease button 546. The sound emission/mute switch button 542 switches between sound emission and mute. The user can switch between sound emission and mute by touching the sound emission/mute switch button 542. The sound emission indicates that the sound is emitted at a set volume. The mute indicates that the sound is caused to not be emitted. The volume increase button 544 is a button for increasing the volume. The user can increase the volume by touching the volume increase button 544. The volume decrease button 546 is a button for decreasing the volume. The user can decrease the volume by touching the volume decrease button 546.

The end button 550 is a button for ending the remote operation with respect to the display apparatus 20. When the end button 550 is touched by the user, the home screen 400 illustrated in FIG. 6 is displayed.

When input for logging into the service via the main application 241 (first application) is detected, the controller 23 determines whether specific information is stored in the storage 24. For example, the controller 23 determines whether the agent application 242 (second application) cooperating with the main application 241 is stored in the storage 24 as the specific information.

The controller 23 controls the display 21 to perform notification of information indicating that there is a possibility that the input attribute and an appropriate attribute are different from each other in accordance with the determination result of whether the agent application 242 is stored in the storage 24 and the attribute of the account having logged into the service.

In this case, the input attribute indicates the attribute of the account having logged into the service. The appropriate attribute indicates an attribute of an account that is originally expected to log into the apparatus from the application being executed in the apparatus, and an appropriate attribute of the account. In the present embodiment, as for the appropriate attribute, in a case where the specific information is stored, the attribute of the account that logs into the service takes “shared account” as the appropriate attribute.

In the apparatus, in a case where the specific information is not stored, the attribute of the account that logs into the service may take “personal account” as the appropriate attribute.

Thus, in a case where the user has not logged into the main application 241 with the appropriate account, the user can recognize that the login account may be inappropriate by checking the information provided as notification on the display 21. Accordingly, it is possible to re-execute login with the appropriate account based on the information provided as notification on the display 21. This makes it possible to execute the application in the appropriate operation mode.

The agent application 242 is typically installed in the display apparatus 20, which is used being shared, as illustrated in FIG. 2. Accordingly, in the case where the agent application 242 is installed, when login is performed using a personal account, there is a high possibility that the login is performed using a wrong account. Therefore, in the case where it is determined that the agent application 242 (second application) is stored in the storage 24, when the input attribute is determined to be a personal account (first attribute), the controller 23 controls the display 21 (notifier) to perform notification of the information indicating that the input attribute may be different from the appropriate attribute. Thus, by checking the information provided as notification on the display 21, the user can recognize that the login account may be inappropriate. Therefore, it is possible to re-execute login with the appropriate account (shared account) based on the information provided as notification on the display 21. As a result, the application can be executed in the appropriate operation mode (shared PC operation mode).

The agent application 242 (second application) is typically installed in the display apparatus 20 used being shared, as illustrated in FIG. 2. That is, typically, as illustrated in FIG. 2, the agent application 242 is installed in neither the personal computer 30 for personal use nor the smartphone 40 for personal use. Accordingly, in the case where the agent application 242 is not installed, when login is performed using a shared account, there is a high possibility that the login is performed using a wrong account. For example, in the case where it is determined that the agent application 242 (second application) is not stored in the storage 33, when the input attribute is determined to be a shared account (second attribute), the controller 32 of the personal computer 30 controls the display 31 (notifier) to perform notification of the information indicating that the input attribute may be different from the appropriate attribute. Thus, by checking the information provided as notification on the display 31, the user can recognize that the login account may be inappropriate. Therefore, it is possible to re-execute login with the appropriate account (personal account) based on the information provided as notification on the display 31. As a result, the application can be executed in the appropriate operation mode (personal operation mode).

Similarly, for example, in the case where it is determined that the agent application 242 (second application) is not stored in the storage 44, when the input attribute is determined to be a shared account (second attribute), the controller 43 of the smartphone 40 controls the display 41 (notifier) to perform notification of the information indicating that the input attribute may be different from the appropriate attribute. Thus, by checking the information provided as notification on the display 41, the user can recognize that the login account may be inappropriate. Therefore, it is possible to re-execute login with the appropriate account (personal account) based on the information provided as notification on the display 41. As a result, the application can be executed in the appropriate operation mode (personal operation mode).

In the case where it is determined that the agent application 242 (second application) is stored in the storage 24, when the input attribute is determined to be a personal account (first attribute), the controller 23 controls the display 21 (notifier) to notify the user of information that proposes re-login. Therefore, it is possible to re-execute login with the appropriate account (shared account) based on the information provided as notification on the display 21. As a result, the application can be executed in the appropriate operation mode (shared operation mode).

In the case where it is determined that the agent application 242 (second application) is stored in the storage 24, when the input attribute is determined to be a shared account (second attribute), the controller 23 permits the login into the service. Therefore, when the login is performed using the appropriate account, the application can be executed in the appropriate operation mode (shared operation mode) without notifying the display 21 of the information.

The agent application 242 (second application) executes intermediate processing for operation information from the personal computer 30 or the smartphone 40 (external terminal). Thus, the display apparatus 20 (information processing apparatus) can be remotely operated from the personal computer 30 or the smartphone 40. Here, the operation information is information regarding operation having been input in the personal computer 30 or the smartphone 40 as an external terminal. For example, the external terminal transmits to the display apparatus 20 a detected operation, such as an operation of a cursor key, a movement operation of a mouse cursor, a key input, a touch operation, or an operation of a trackpad as the operation information. The operation information may be information based on the content of an operation generally performed at the external terminal or may be information acquired by the main application (e.g., information based on an operation detected on a trackpad screen displayed in the main application).

When the login to the service is permitted, the agent application 242 (second application) causes the display 21 (notifier) to display an image indicating connection information regarding connection of the remote operation from the external terminal. This makes it possible to establish connection for the remote operation from the external terminal by using the connection information.

The connection information includes at least one of a two-dimensional code or a character string. Therefore, the smartphone 40 and the display apparatus 20 (information processing apparatus) can be easily connected to each other by reading the two-dimensional code or the character string by using the camera of the smartphone 40 (external terminal). Further, the personal computer 30 and the display apparatus 20 (information processing apparatus) can be easily connected to each other by inputting the character string to the personal computer 30 (external terminal).

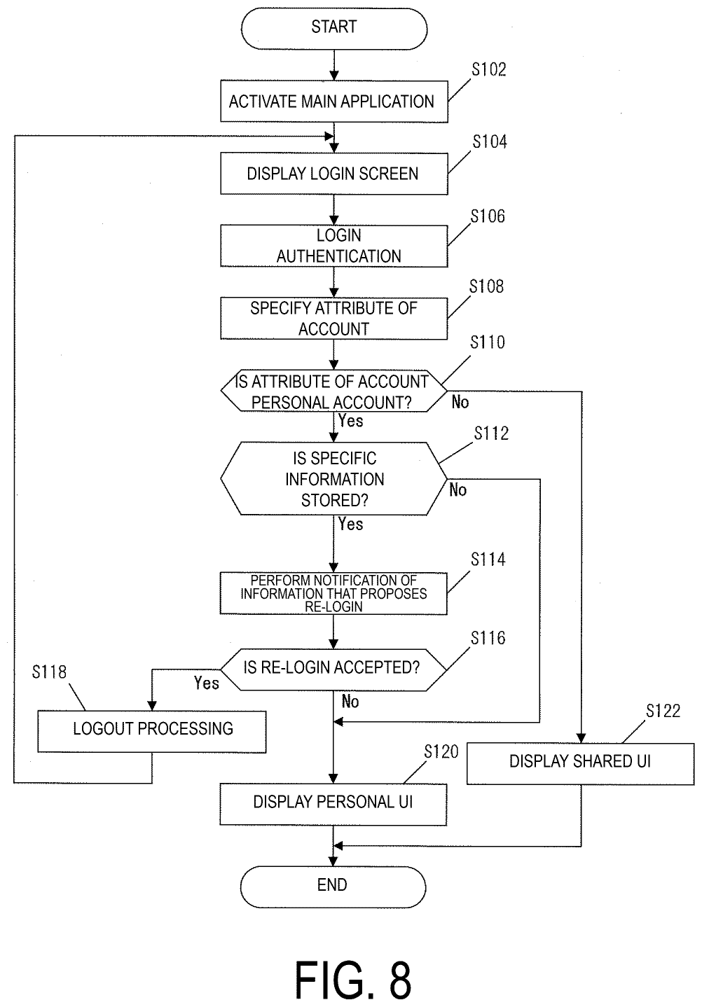

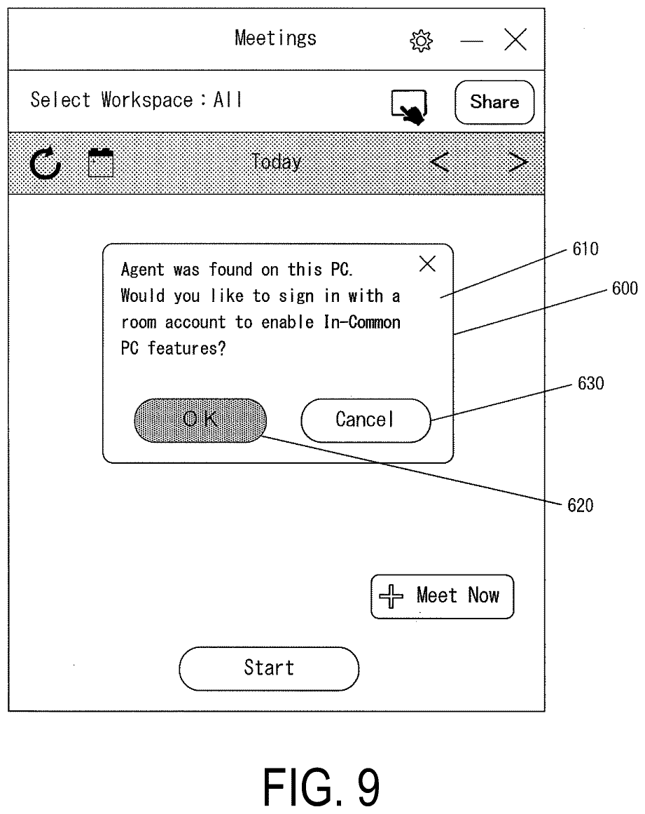

A login control method of the information processing apparatuses (the display apparatus 20, personal computer 30, and smartphone 40) according to the embodiment of the disclosure will be described with reference to FIGS. 1 to 9. The login control method is a method for controlling the login by the main application 241 to the service provided by the server 50. FIG. 8 is a flowchart illustrating the login control method of the information processing apparatuses (the display apparatus 20, personal computer 30, and smartphone 40) according to the embodiment of the disclosure. FIG. 9 is a diagram illustrating an example of a display screen displayed on the display 21 of the display apparatus 20. The login control is performed by executing a process from step S102 to step S122 illustrated in FIG. 8. Hereinafter, a case where the information processing apparatus is the display apparatus 20 will be described. However, the same process is carried out in the personal computer 30 and the smartphone 40.

The controller 23 activates the main application 241 (S102). The controller 23 displays the login screen 200 as the third screen on the display 21 (S104).

The controller 23 executes login authentication (S106). For example, the controller 23 transmits a login request including account information (login ID and password) input by a user to the server 50. Then, the controller 23 receives a login response from the server 50. Here, the controller 23 may stop the process when the login response indicates that the login has failed.

The controller 23 identifies the attribute of the account included in the login response (S108). In the present embodiment, the server 50 performs login authentication to identify the attribute of the account. However, a different method may be employed. For example, the controller 23 may perform login authentication locally (for example, in the display apparatus 20) and may acquire the attribute of the account from a license management server. Further, the controller 23 may perform login authentication by an external server (for example, an OAuth server), and the attribute of the account may be identified from information stored in the display apparatus 20 or may be identified by acquiring from the license management server.

The controller 23 determines whether the attribute of the account is a personal account or a shared account (S110). Here, when the attribute of the account is a shared account (not a personal account) (S110; No), the controller 23 displays the shared screen (second screen) (S122). At this time, the controller 23 may execute the main application in the second operation mode.

On the other hand, when the attribute of the account is a personal account (S110; Yes), the controller 23 checks whether specific information is stored in the storage 24 (S112).

In this case, the specific information being stored refers to the following states.

### (1) an Application Related to the Main Application is Stored

For example, the agent application may be stored in the storage 24 or may be executed. The agent application may be an independent execution file, or may be a file activated as a service.

As described above, the agent application is an application capable of providing a function for assisting the conference service. For example, the agent application can provide a cooperative function with the smartphone 40 or monitor the operation of the main application.

### (2) Stored as a Setting File

For example, a specific file and data (e.g., a setting file (INI file) and a data file (DAT file)) are stored together with the main application. The controller 23 may determine whether the specific file and data are stored in a predetermined folder or directory.

### (3) Information is Stored in a Definition File

For example, predetermined information is stored in a definition file (e.g., a registry file) of the system. For example, in a case of the registry file, the controller 23 may determine whether a predetermined registry key is stored.

In the case of the shared information processing apparatus, for example, the specific information is preferably installed together with the main application when installing the main application by designating that the information processing apparatus is shared. Alternatively, an administrator or the like may later install a specific function in the shared information processing apparatus.

Then, when the controller 23 determines that the specific information is stored, it is preferable to log into the service with a shared account because the apparatus is an apparatus for sharing. Accordingly, information for proposing re-login is provided as notification (S112; Yes→S114).

Specifically, as illustrated in FIG. 9, the controller 23 controls the display 21 to display a re-login proposal screen 600 on the display 21. The re-login proposal screen 600 includes a message image 610, an OK button 620, and a cancel button 630. The message image 610 is, for example, an image of a message indicating the information that proposes re-login. The OK button 620 is a button for determining to accept the re-login proposal. A cancel button 630 is a button for determining not to accept the re-login proposal.

The controller 23 determines whether the user has accepted the re-login (S116). When the controller 23 determines that the user does not accept the re-login (step S116; No), a personal UI, which is the first screen, is displayed as it is (S120). At this time, the controller 23 may execute the main application in the first operation mode.

In addition, when the controller 23 determines that the user has accepted the re-login (step S116; Yes), the controller 23 once executes logout processing of the account (personal account) which is currently in a login state (S118). Then, the controller 23 causes the display 21 to display the login screen 200 again (S104). Thus, based on the information proposed in step S114, the user can re-login with an appropriate account to the apparatus in which the main application is currently being executed.

When the specific information is not stored, the controller 23 displays the personal UI (user interface) on the display 21 (S112; No→S120). Specifically, the controller 23 causes the display 21 to display the home screen 400 (see FIG. 6). That is, the controller 23 executes the main application in the first operation mode.

In the case where the process of FIG. 8 is described with reference to the configuration of FIG. 2, when the display apparatus 20 executes, the storage 24 stores the agent application 242 as the specific information. Accordingly, when the user logs into the service with a personal account, the controller 23 performs notification of the information that proposes re-login (S110; Yes→S112; Yes→S114).

When the personal computer 30 similarly executes, the storage 33 does not store the specific information. Therefore, when the user performs login with a personal account, the controller 23 displays the personal UI, which is the first screen, as it is (S110; Yes→S112; No→S120).

In the login control method described with reference to FIG. 8, in step S116, the controller 23 changes the process based on whether the re-login is accepted, but the disclosure is not limited thereto. For example, the controller 23 may execute the logout processing without determining, by the controller 23, whether the re-login is accepted.

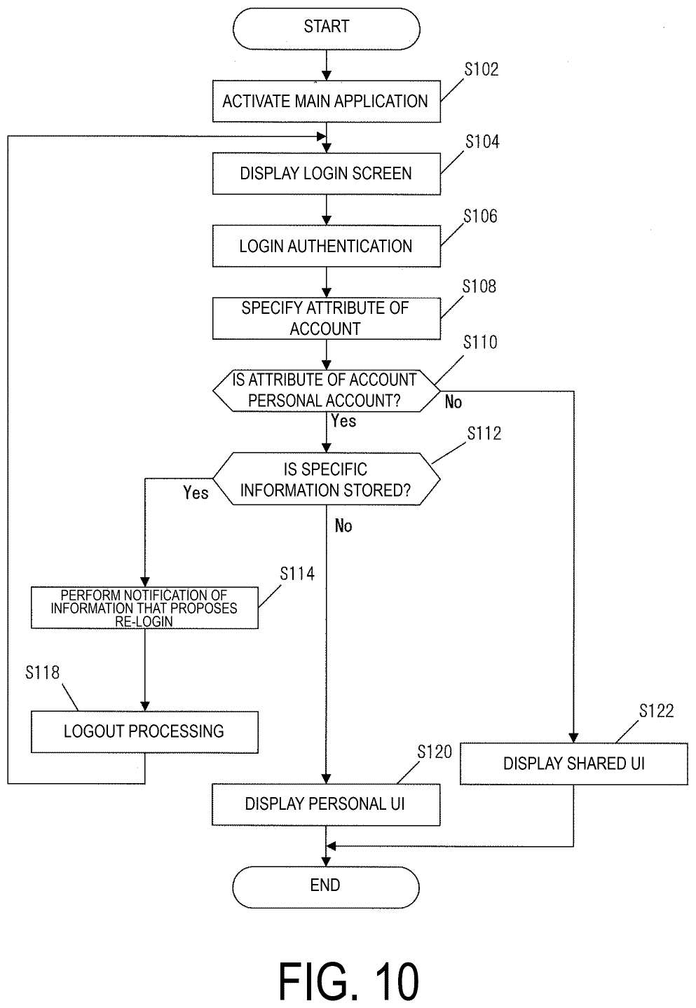

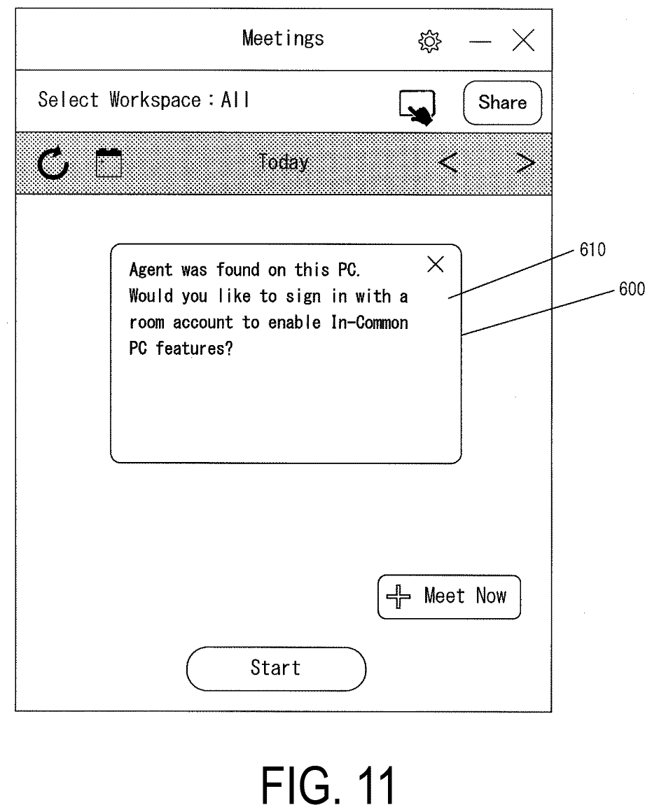

A login control method of the information processing apparatuses (the display apparatus 20, personal computer 30, and smartphone 40) according to the embodiment of the disclosure will be described with reference to FIGS. 10 and 11. FIG. 10 is a flowchart illustrating the login control method of the information processing apparatuses (the display apparatus 20, personal computer 30, and smartphone 40) according to the embodiment of the disclosure. FIG. 11 is a diagram illustrating an example of a display screen displayed on the display 21 of the display apparatus 20. The login control is performed by executing a process from step S102 to step S122 illustrated in FIG. 10. The flowchart illustrated in FIG. 10 is the same as the flowchart illustrated in FIG. 8 except that the processing of step S116 is not carried out, and redundant description is omitted to avoid redundancy. Hereinafter, a case where the information processing apparatus is the display apparatus 20 will be described. However, the same process is carried out in the personal computer 30 and the smartphone 40.

Step S102 to step S112: the same process as that of step S102 to step S112 illustrated in FIG. 8 is carried out.

Step S114: the controller 23 controls the display 21 to perform notification of information that proposes re-login. Specifically, as illustrated in FIG. 11, the controller 23 controls the display 21 to display the re-login proposal screen 600 on the display 21. As illustrated in FIG. 11, the re-login proposal screen 600 includes the message image 610. In this case, the re-login proposal screen 600 includes neither the OK button 620 nor the cancel button 630 illustrated in FIG. 9. The re-login proposal screen 600 may include the OK button 620 in addition to the message image 610. The process proceeds to step S118, and logout processing is carried out.

Step S118 to step S122: the same process as that of step S118 to step S122 illustrated in FIG. 8 is carried out.

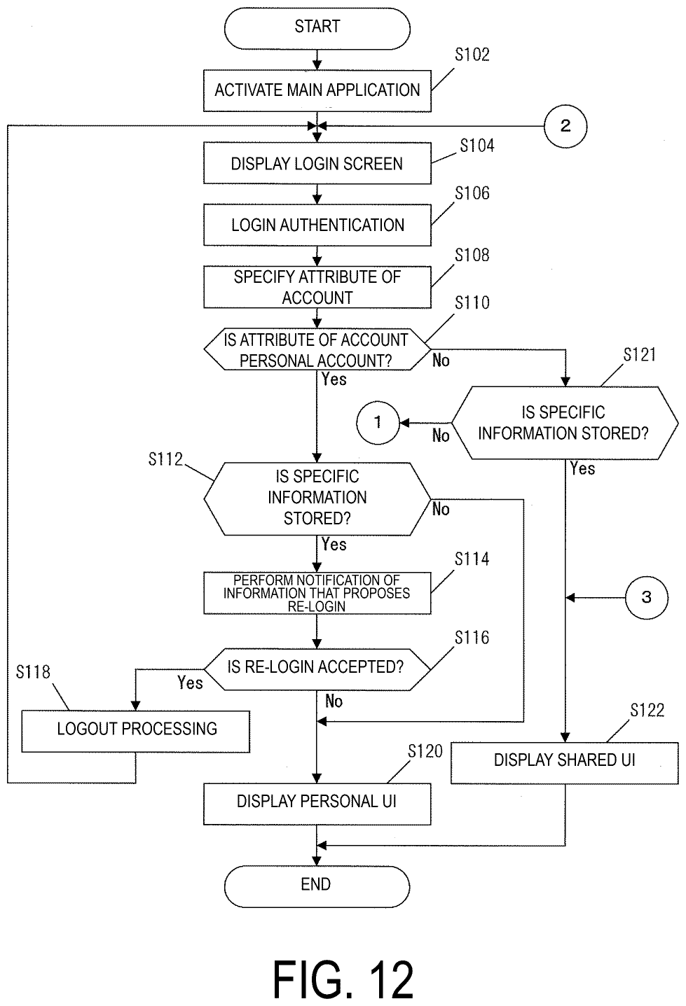

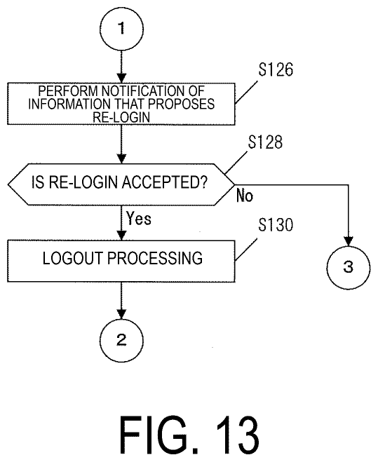

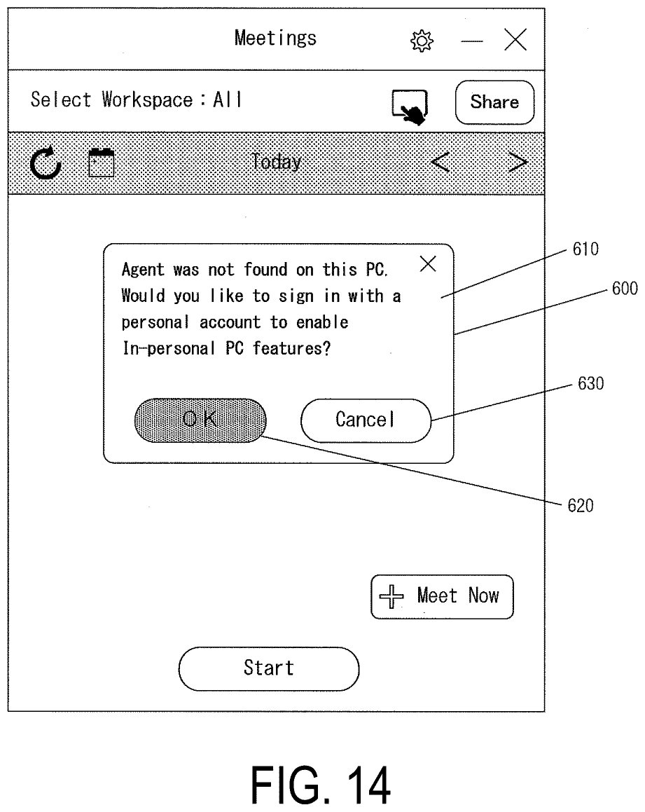

A login control method of the information processing apparatuses (the display apparatus 20, personal computer 30, and smartphone 40) according to the embodiment of the disclosure will be described with reference to FIGS. 12 to 14. FIG. 12 and FIG. 13 are each a flowchart illustrating the login control method of the information processing apparatuses (the display apparatus 20, personal computer 30, and smartphone 40) according to the embodiment of the disclosure. FIG. 14 is a diagram illustrating the display 21 of the display apparatus 20. The login control is performed by executing a process from step S102 to step S122 illustrated in FIG. 12 and from step S126 to step S130 illustrated in FIG. 13. The flowcharts illustrated in FIGS. 12 and 13 are different from the flowchart illustrated in FIG. 8 in that processing of step S121 is carried out when processing of step S110 is determined to be No, and redundant description will be omitted to avoid redundancy. Hereinafter, a case where the information processing apparatus is the display apparatus 20 will be described. However, the same process is carried out in the personal computer 30 and the smartphone 40.

Step S118 to step S120: the same process as that of step S118 to step S120 illustrated in FIG. 8 is carried out.

Step S121: the controller 23 determines whether specific information (e.g., the agent application 242) is stored in the storage 24. When the controller 23 determines that the specific information (e.g., the agent application 242) is not stored in the storage 24 (step S121; No), the process proceeds to step S126 illustrated in FIG. 13. When the controller 23 determines that the agent application 242 is stored in the storage 24 (step S121; Yes), the process proceeds to step S122.

Step S122: the controller 23 displays a shared UI (user interface). Specifically, the controller 23 causes the display 21 to display the home screen 300 (see FIG. 5). Then, the process ends.

Step S126: the controller 23 controls the display 21 to perform notification of information that proposes re-login. Specifically, as illustrated in FIG. 14, the controller 23 controls the display 21 to display the re-login proposal screen 600 on the display 21. The re-login proposal screen 600 includes the message image 610, the OK button 620, and the cancel button 630. The message image 610 is, for example, an image of a message indicating the information that proposes re-login. The OK button 620 is a button for determining to accept the re-login proposal. The cancel button 630 is a button for determining to not accept the re-login proposal. The process proceeds to step S128.

Step S128: the controller 23 determines whether the user has accepted the re-login. When the controller 23 determines that the user does not accept the re-login (step S128; No), the process proceeds to step S122 illustrated in FIG. 12. When the controller 23 determines that the user accepts the re-login (step S128; Yes), the process proceeds to step S130.

The embodiment of the disclosure has been described thus far with reference to the drawings (FIGS. 1 to 14). However, the disclosure is not limited to the above-described embodiment, and can be implemented in various forms without departing from the gist of the disclosure. In order to facilitate understanding, the drawings are illustrated schematically, focusing on the respective constituent elements, and thicknesses, lengths, numbers, and the like of the illustrated constituent elements are different from actual ones for convenience of creating drawings. In addition, the materials, the shapes, the dimensions, and the like of the respective constituent elements illustrated in the above-described embodiment are merely examples and are not particularly limited, and various changes can be made without substantially departing from the advantageous effects of the disclosure.

In the login control method described above with reference to FIG. 8, the entirety of the process from step S102 to step S122 is carried out by one information processing apparatus (the display apparatus 20, personal computer 30, or smartphone 40), but the disclosure is not limited thereto. For example, some of steps S102 to S122 may be carried out by other apparatuses. For example, the process from step S102 to step S108 among step S102 to step S122 may be carried out by the server 50. Alternatively, some of steps S102 to S122 may be carried out by the display apparatus 20, some thereof may be carried out by the personal computer 30, and some thereof may be carried out by the smartphone 40.

1. An information processing apparatus, comprising:
a storage; and
a controller, wherein
the controller
displays a first screen in a case that a user logs into a service using a first attribute account,
displays a second screen in a case that the user logs into the service using a second attribute account, and
displays information requesting input of the second attribute account in a case that specific information is stored in the storage at a time of logging into the service using the first attribute account.

2. The information processing apparatus according to claim 1, wherein
the controller permits login authentication with the second attribute account in a case that the specific information is stored in the storage.

3. The information processing apparatus according to claim 1, wherein
the specific information is a specific application, and
the controller displays information requesting input of the second attribute account in a case that the specific application is stored in the storage.

4. The information processing apparatus according to claim 3, wherein
the controller displays information requesting input of the second attribute account in a case that the specific application is being executed by the controller.

5. The information processing apparatus according to claim 3, further comprising a communicator that communicates with a terminal apparatus, wherein
the controller acquires operation information from the terminal apparatus via the communicator by executing the specific application, and controls the information processing apparatus based on the operation information.

6. The information processing apparatus according to claim 5, wherein
the controller outputs connection information with which the terminal apparatus is connected, in a case that login authentication with the second attribute account is permitted by executing the specific application.

7. The information processing apparatus according to claim 6, wherein
the controller displays the connection information output by the specific application on the second screen in a state of being readable by the terminal apparatus.

8. The information processing apparatus according to claim 1, further comprising a communicator that communicates with a server apparatus that provides the service, wherein the controller acquires an attribute of the account from the server apparatus via the communicator, and
the attribute of the account is determined based on a type of a license assigned to the account in the server apparatus.

9. The information processing apparatus according to claim 8, wherein
the attribute of the account is determined by whether the license is assigned to the account in the server apparatus.

10. The information processing apparatus according to claim 1, wherein
the controller displays a third screen to log into the service, and displays one of the first screen and the second screen after login authentication is performed on the third screen.

11. A system comprising:
a server apparatus that provides a service; and
a display apparatus that executes a first application communicating with the service, wherein
the display apparatus
executes the first application in such a manner as to display with a first user interface in a case that a user logs into the service using a first attribute account,
executes the first application in such a manner as to display with a second user interface in a case that the user logs into the service using a second attribute account, and
displays information requesting the user to log into the service using the second attribute account in a case that the second application is installed in the display apparatus and that the user logs into the service using the first attribute account.

12. The system according to claim 11, wherein
the first user interface includes information regarding the display apparatus in which the first application is executing in such a manner as to be displayed with the second user interface.

13. A display method of an information processing apparatus including a storage, the method comprising:
displaying any of a first screen in a case that a user logs into a service using a first attribute account and a second screen in a case that the user logs into the service using a second attribute account; and
displaying information requesting input of the second attribute account in a case that specific information is stored in the storage at a time of logging into the service using the first attribute account.
